(19) United States
(12) Patent Application Publication
(10) Pub. No.: US 2026/0233967 A1
(43) Pub. Date: Aug. 13, 2026

(54) ELEVATOR SYSTEM HAVING INDIVIDUAL USER INTERFACES ON ELEVATOR OPERATING DEVICES

(71) Applicant: INVENTIO AG, Hergiswil (CH)

(72) Inventors: Lukas Finschi, Ebikon (CH); Martin Egli, Ermensee (CH); Kilian Ineichen, Malters (CH); Aleksandar Postolov, Cham (CH)

(21) Appl. No.: 19/155,882

(22) PCT Filed: Apr. 8, 2024
(86) PCT No.: PCT/EP2024/059430

§ 371 Date: Aug. 12, 2025

(30) Foreign Application Priority Data
Apr. 12, 2023 (EP) 23167472.2

(51) Int. Cl. B66B 1/46; B66B 3/00

(52) U.S. Cl. CPC B66B 1/468; B66B 3/002; B66B 2201/101; B66B 2201/103; B66B 2201/4615; B66B 2201/463; B66B 2201/4638; B66B 2201/4653; B66B 2201/4676

(57) ABSTRACT

In an elevator system having a control device, an elevator car that can move between floors, and an elevator operating device having a display device, a person can adjust a user interface. This is indicated by a received configuration command. A received configuration signal comprises a custom display instruction set by the person, wherein the custom display instruction modifies a default user interface or an existing custom user interface. In a storage device, the custom display instruction is assigned to a usage feature that is assigned to the first person Jor to one or more additional persons for whom the custom display instruction is valid. When a usage feature is received that corresponds to the one that is stored, the display device displays a custom user interface.

### DESCRIPTION

The technology described herein generally relates to an elevator system comprising an elevator operating device. Exemplary embodiments of the technology also relate to a method for operating such an elevator system.

In order for a person to be able to call an elevator, elevator systems are known which either have an elevator operating device for entering the desired direction of travel (e.g., “up” and “down” buttons), or an elevator operating device for entering the desired destination floor. The latter is possible with elevator systems having a destination call control system which allocates an elevator car to an elevator call made by a person in order to transport the person to a desired destination floor. One exemplary embodiment of an elevator system comprising a destination call control system is disclosed in EP 0 443 188 B1 ; the call allocation is made on the basis of calculated operating costs.

In known elevator systems, interactions between people and the elevator system are substantially limited to calling an elevator. However, depending on the size and complexity of a building and its use, additional interaction options may be desirable. There is therefore a need for a technology which creates such additional interaction options in an elevator system.

One aspect of such improved technology relates to a method for operating an elevator system. The elevator system comprises a control device, an elevator car that can move between floors, and an elevator operating device having a display device. The elevator operating device is designed to activate the display device to display a user interface. The method involves receiving a configuration command by means of the control device, wherein the configuration command indicates that a first person wishes to modify a default user interface or an existing custom user interface. The control device receives a configuration signal comprising a custom display instruction set by the first person. The custom display instruction modifies the default user interface or the existing custom user interface. The custom display instruction is stored in a storage device, wherein the custom display instruction is assigned to a usage feature in the storage device; the usage feature is assigned to the first person or one or more additional persons for whom the custom display instruction is valid. The control device is designed to activate the display device according to the custom display instruction upon receipt of a usage feature that corresponds to the one stored in the storage device, wherein the display device displays a current custom user interface.

Another aspect of such improved technology relates to an elevator system. The elevator system comprises an elevator car that can move between floors, a storage device, a control device and an elevator operating device that comprises a display device. The elevator operating device is configured to activate the display device to display a user interface, and the control device is configured to receive a configuration command. The configuration command indicates that a first person wishes to modify a default user interface or an existing custom user interface. The elevator operating device is also designed to receive a configuration signal comprising a custom display instruction set by the first person. The custom display instruction modifies the default user interface or the existing custom user interface. The elevator operating device is also designed to cause the custom display instruction to be stored in the storage device. The custom display instruction is assigned to a usage feature in the storage device, wherein the usage feature is assigned to the first person or one or more additional persons for whom the custom display instruction is valid. Furthermore, the control device is designed to activate the display device according to the custom display instruction upon receipt of a usage feature that corresponds to the one stored in the storage device, wherein the display device displays a custom user interface.

The technology described here enables an elevator system to be operated in such a way that it provides additional ways for a passenger and an elevator operating device to interact. This is made possible in particular by the fact that a person can customize the configuration of the user interface of an elevator control device. The person can configure the user interface to be personalized for themselves and/or members of a user group. The user interfaces are therefore no longer set or determined exclusively by the system, i.e. by the elevator system, but by the users of the elevator system, if they so wish. This can make it easier to operate the elevator control devices, especially when they are used in a larger and complex building.

The person can be assigned to a user group, wherein a single uniform user interface can be set for the persons (members) of the user group, i.e. all group members see and use the same user interface. From an organizational perspective, the person can be an individual who is not assigned to a user group; this person can set the desired custom user interface for themselves.

Users (individuals or user group(s)) can optionally set custom user interfaces; if they choose to do so they can choose how and to what extent they want to customize the user interface. If they choose not to set custom user interfaces, an elevator operating device displays a default user interface.

For example, an individual can set a graphic design of the user interface and/or its content. In order to create such a possibility for a custom user interface, a user profile can be stored for the person in the elevator system, in which the person can set a custom display instruction according to which the user interface is to be displayed. Similarly, a user profile can be stored for a user group (e.g. managed by a person responsible for the user group), in which a custom display instruction is set for the user group.

A person must be authorized to configure a user interface. In an exemplary embodiment applicable in conjunction with any one of the exemplary embodiments disclosed in this description, the method involves receiving the usage feature of the person by means of the control device and using the control device to check whether authorization to modify a user interface (default user interface or existing custom user interface) is stored in the storage device for the usage feature of the person. If authorized, the display device is activated to display a configuration user interface; if not authorized, the display device is activated to display an error message.

Options for setting the custom display instruction in a user profile can be adapted to the elevator system and/or the building. Accordingly, more extensive or less extensive specifications may be possible in the user profile. In one exemplary embodiment, the displayed configuration user interface shows the options for the custom display instruction. The custom display instruction can, for example, set at least one arrangement of input and/or output fields on the user interface, a shape of the input and/or output fields, a color of the input and/or output fields, a color and/or motif of a background of the custom user interface (e.g. in the form of a still image or a video), a font and/or a pictogram for the custom user interface. Depending on the building and/or the use of the building, dynamic content, such as weather reports, road traffic situations, bus/train timetables, restaurant or cafeteria menus, or news, can be set according to the interests of the person or user group.

In an exemplary embodiment applicable in conjunction with any one of the exemplary embodiments disclosed in this description, the usage feature may be a password (e.g., numeric or alphanumeric) or a template of a biometric feature. The password can be determined by a recording device from a scanned optical code, a received electrical signal or a received radio signal. The template can be determined by the recording device from an image of the person's face or another of their biometric features. The type of usage feature provided for the elevator system can be set to correspond to, or at least be compatible with, the technology that may be used in the building for other purposes, such as for an access control system. The recording device is designed in accordance with the type of usage feature, for example having a camera, a radio device or a reader (scanner). Those skilled in the art will recognize that the recording device can be configured to record multiple different types of usage features; for example, to record an optical code and a radio signal or a template; the technologies (or their components) of the recording device required for this purpose can be arranged in a single housing (e.g., the elevator operating device) or can be separately arranged in different housings. The technology described herein therefore does not restrict design freedom in terms of the technical implementation of the usage feature.

There is also a degree of design freedom with respect to the arrangement of the storage device. In an exemplary embodiment that is applicable in conjunction with any one of the exemplary embodiments disclosed in this description, the storage device can be arranged in the elevator operating device. In another exemplary embodiment, the storage device may be arranged so as to be connected to the control device of the elevator system, either arranged locally in the building or remotely therefrom connected to a so-called cloud application.

Various aspects of the improved technology are described in greater detail below in conjunction with the drawings with reference to exemplary embodiments. In the figures, identical elements have identical reference signs. In the figures:

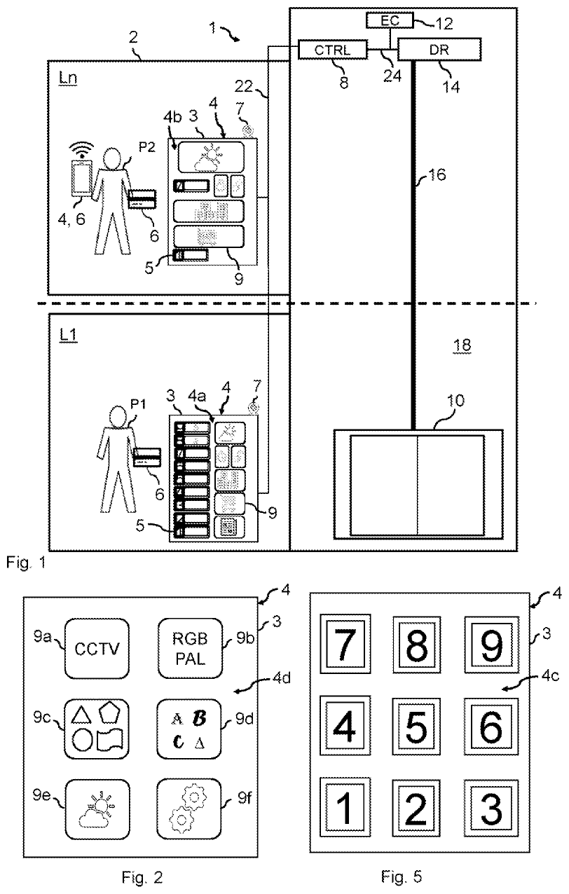

FIG. 1 shows a schematic representation of an exemplary embodiment of an elevator system in a building having multiple floors,

FIG. 2 is a schematic view of an exemplary embodiment of a configuration user interface;

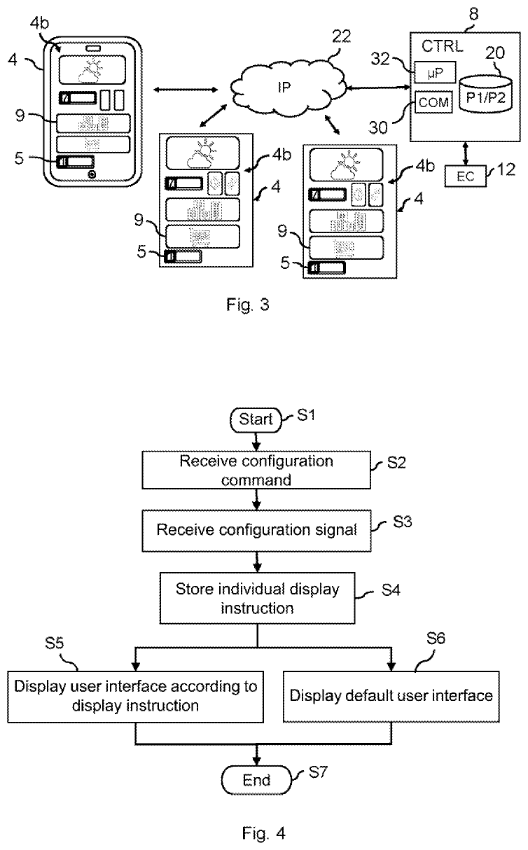

FIG. 3 is a schematic view of an exemplary embodiment of a communication structure between operating devices and a control device of the elevator system;

FIG. 4 shows an example representation of an exemplary embodiment of a method for operating the elevator system; and

FIG. 5 is a schematic view of an exemplary embodiment of a default user interface of an elevator operating device.

FIG. 1 is a schematic view of an exemplary embodiment of an elevator system 1 in a building 2; the building 2 can in principle be any type of multi-story building (e.g., residential building, hotel, office building, sports stadium, etc.). The building can be used for commercial purposes (e.g. as an office and business premises, hotel or hospital), non-commercial purposes (e.g. residential buildings) or mixed commercial and non-commercial purposes. In another application example, the elevator system 1 can be installed on a ship (e.g., a passenger ship). The technology disclosed herein is described below with reference to a building but without being restricted thereto.

The building 2 shown in FIG. 1 comprises several floors L1, Ln (n=number of floors) on which elevator operating devices 4 are arranged. The floors L1, Ln are served by the elevator system 1, i.e., a person P1, P2 can call an elevator at an elevator operating device 4 in order to then be transported by the elevator system 1 from the floor where the call was made to a destination floor. The floor where the call is made can also be referred to as the boarding floor.

The elevator operating devices 4 each have a display device 3 (e.g. as part of a touch-sensitive screen system), which can be activated either to display a default user interface 4c (standard user interface), shown in FIG. 5, or a custom user interface 4a, 4b. The default user interface 4c displays, for example, a number of keys, each key being assigned to a floor. In FIG. 5, for example, floors 1-9 are shown, it being possible for additional fields to be displayed (e.g., for operation by persons with mobility restrictions).

In FIG. 1, the elevator operating devices 4 display examples of custom user interfaces 4a, 4b that are set after being configured (also referred to as modified) by the persons P1, P2 (or for the persons P1, P2) according to the technology described herein. In the exemplary embodiment shown, the person P1 is shown on the floor LI near the elevator operating device 4. The display device 3 of the elevator operating device 4 displays a first user interface 4a. The person P2 is located on the floor Ln, and the elevator operating device 4 arranged there displays a second user interface 4b. It can be seen in FIG. 1 that the user interfaces 4a, 4b are different.

The user interfaces 4a, 4b are specific to a person P1, P2 or a user group, i.e., the user interface 4a is customized for the person P1 currently present there, and the user interface 4b is customized for the person P2 currently present there, because they are configured, for example, by or for the persons P1, P2. If the person P1, P2 belongs to a user group, e.g. employees of a specific company, the user interface 4a, 4b that is set for the user group (e.g. configured by a person responsible for the user group) is displayed for them.

Said configuration can be carried out on an elevator operating device 4, on a mobile device or on a computer. In conjunction with FIG. 3 it is stated that a correspondingly designed mobile device can be used as the elevator operating device 4. This can be performed on the mobile device and the computer, for example, after a login process via a web browser application. If an elevator-specific software application (elevator app) is installed on the mobile device, the person P1, P2 can perform the desired configuration using the elevator app. A user interface can be provided to assist with the configuration. FIG. 2 shows an example of a configuration user interface 4d, such as that displayed by the display device 3 of the elevator operating device 4; on this basis, a description of the configuration according to the technology described here shall follow. Those skilled in the art will recognize that a mobile device and a computer monitor can display such configuration user interfaces in an analogous manner.

The configuration user interface 4d shown by way of example comprises selection fields 9a-9f, which can each be selectively chosen to open a configuration window for a custom display instruction. It is generally known to those skilled in the art how to program and activate such fields and to open them to display detailed information or further selection options, for example from the programming and use of software applications (apps) on smartphones or computers.

The selection field 9a allows a motif, a still image or a video recording to be set as a custom display instruction, for example as a background image of the custom user interface 4a, 4b or, in the case of a video recording, in a separate display window of the custom user interface 4a, 4b. The video recording can, for example, be a real-time recording (CCTV) of an elevator lobby. The motif or still image may be content that the person P1, P2 provides (saves) in advance or is provided by the elevator system 1 as standard.

The selection field 9b allows a color scheme to be set for the user interface 4a, 4b as a custom display instruction, for example of the background. In addition, the color of input and/or output fields 5, 9, which display the user interfaces 4a, 4b, can be customized.

The selection field 9c allows a shape to be set for the input and/or output fields 5, 9 of the user interface 4a, 4b as a custom display instruction. The selection field 9d allows a font to be set for the input and/or output fields 5, 9 of the user interface 4a, 4b as a custom display instruction.

The selection fields 9e and 9f allow desired information (e.g. current weather information, building information and/or elevator information (e.g. destination floors to be displayed)) and corresponding animations, symbols and/or pictograms to be set as custom display instructions. The user interfaces 4a, 4b then display the desired information, for example weather information, building information (e.g. a building plan) and information for shopping opportunities in the building 2. Those skilled in the art shall recognize that, depending on the building and/or the use of the building, dynamic content, such as road traffic situations, bus/train timetables, restaurant or cafeteria menu offers, or news, can be set according to the interests of the person or user group.

Those skilled in the art will also recognize that said configuration options are examples; depending on the building and elevator system 1, more or fewer configuration options may be available. The extent to which the color, shape and font are designed can be set by the elevator system 1. Those skilled in the art also recognize that the configuration options can be combined with one another (e.g. color scheme and font). In an application example, for a user group, e.g., employees of a particular company, the user interface 4a, 4b can be configured to display, for example, a company logo and/or the font and color scheme of the background can be designed according to the company's appearance (“corporate identity”).

If a person P1, P2 has completed the configuration of the user interface 4a, 4b, or, in the case of a user group, if it has been completed for the person P1, P2, the user interface 4a, 4b can be displayed to the person P1, P2 when they are using the elevator system 1. Referring again to FIG. 1, the user interface 4a displays, for example, a plurality of destination floor fields 5 arranged vertically one above the other next to a plurality of different information fields 9, whereas the user interface 4b displays, for example, only two destination floor fields 5 between the information fields 9. The destination floor fields 5 can, for example, be numbered (e.g., floors L1-Ln), labeled (e.g., with names) and/or marked with symbols. If a person P1, P2 touches one of the destination floor fields 5, a destination call is registered on the floor assigned to the field 42 that was touched. Similarly, the information fields 9 can be labeled and/or marked; when one of the information fields 9 is touched, additional information associated with this information field 9 can be displayed.

Depending on the configuration, the information fields 9 may include animations, dynamic content, static or animated representations or pictograms, for example for current weather information, building information (e.g. a building plan) and information for shopping opportunities in the building 2, without being limited to such content, animations, representations or pictograms. Depending on the configuration, a shape or a color scheme can also be set for the displayed fields (5, 9); moreover, a color scheme and/or motif of a background of the user interface 4a, 4b and/or a font for the custom user interface 4a, 4b can be set for the fields (5, 9).

In the exemplary embodiment in FIG. 1, a recording device 7 is arranged on each floor L1, Ln; it can be arranged on or in the elevator operating device 4 or in the region therearound. The recording device 7 can be designed to record a usage feature of a person P1, P2. In one exemplary embodiment, the usage feature identifies the person P1, P2 as authorized to modify the default user interface 4c (FIG. 5) of the elevator operating device 4.

According to one exemplary embodiment, the usage feature can be recorded from an information carrier 6 that a person P1, P2 has on them, for example. In another exemplary embodiment, information known to the person P1, P2 (e.g. PIN or access code) can be provided as the usage feature. According to a further exemplary embodiment, a biometric feature of the person P1, P2 (e.g. obtained from an image of a face) can be provided as the usage feature.

In one exemplary embodiment, the usage feature is an identifier for a user group for whose group members the settings or preferences for the elevator system 1 are set uniformly. The identifier can identify the person P1, P2, for example, as an employee of a specific company. Depending on the design of the elevator system 1 and/or the requirements in the building 2, it may be provided that the identifier is also used to identify the person P1, P2. If not, only the membership of the person P1, P2 to the user group is determined, but not their identity.

In another exemplary embodiment, the usage feature is an identifier for an individual person P1, P2. This allows the person P1, P2 to be identified for whom the settings or preferences for the elevator system 1 are customized. For example, the person P1, P2 can determine these settings or preferences themselves.

The usage feature may be associated with one or more authorizations in the building 2, for example to modify the elevator operating devices 4, to access the building 2 and/or regions within the building 2, or to use the elevator system 1 or other building facilities. Such authorizations can be set for a user group and/or for an individual person P1, P2. In one exemplary embodiment, the usage feature serves to call an elevator and/or to identify or recognize a person P1, P2 as being someone with authority to enter.

If the usage feature is implemented on an information carrier 6, said feature can be determined by the recording device 7 from a scanned optical code (e.g. color code, barcode, QR code), a received electrical signal (e.g. from a chip or magnetic stripe card) or a received radio signal (e.g. from an RFID, NFC, WLAN/WiFi or Bluetooth-enabled device). Accordingly, the information carrier 6 can have various designs, for example as a mobile device (mobile phone, smartphone or the like), a card in the form of a credit card, a pendant or a watch (smartwatch). For illustrative purposes, the information carrier 6 in FIG. 1 in shown on the floor Ln as a mobile phone (smartphone or the like) and in credit card form, with both versions of the information carrier 6 being assigned to the person P2. In one exemplary embodiment, an elevator app is installed on the mobile phone, which enables the person P1, P2 to call an elevator using the mobile phone; in this case, the mobile phone is also an elevator operating device 4.

Those skilled in the art will recognize that an elevator operating device 4 can be arranged so as to be connected to a lock of an access control system; the lock can be arranged on a floor where the persons P1, P2 enter the building 2. On this floor, it may be provided that the persons P1, P2 are recorded at the lock by the recording device 7 in order to check whether they are authorized to access the building 2 or restricted regions within the building 2. The recording device 7 can be integrated into the elevator operating device 4 or arranged in a housing in the vicinity of the elevator operating device 4; both devices (4, 7) can, for example, be integrated in a housing of the lock and communicatively connected to the access control system and the elevator system 1.

If a person P1, P2 at the lock is identified as being authorized to enter, an automatic elevator call to a set destination floor can be initiated; alternatively, the person P1, P2 can enter the desired destination floor on the elevator operating device 4 of the lock.

Components and functions of the exemplary embodiment of the elevator system 1 shown in FIG. 1 will be explained below, insofar as they appear helpful for understanding the technology described herein. The elevator system 1 has an elevator car 10 that can move in an elevator shaft 18 and is connected by a suspension means 16 (cables or belts) to a drive unit (DR) 14 and is suspended on this drive unit 14. This can be a traction elevator, wherein further details, such as a counterweight and guide rails, for example, are not shown in FIG. 1. The elevator controller (EC) 12 is connected to the drive unit 14 and actuates the drive unit 14 in order to move the elevator car 10 in the shaft 18. The operation of a traction elevator, its components and the tasks of an elevator control system 12 are generally known to a person skilled in the art. In another exemplary embodiment, the elevator system 1 can comprise a hydraulic elevator. Those skilled in the art also recognize that the elevator system 1 can comprise a plurality of shafts, multi-cabins, or one or more groups of elevators.

The elevator system 1 shown in FIG. 1 is equipped with a destination call control system, the functionality of which is shown by a control device (CTRL) 8 in the exemplary embodiment shown. In this description, the term “destination call control system” is understood to mean components (e.g., computers, processors, storage devices) and associated control and computer programs which execute the functions described below and/or are involved in their execution. The control device 8 is shown in FIG. 1 so as to represent these components and control and computer programs. Those skilled in the art will recognize that one or more functions of the destination call control system can be carried out in or by one or more elevator operating devices 4. The destination call control system carries out an allocation procedure, the principle of which is described, for example, in the following publication: Koehler, Jana, et al., An AI-Based Approach to Destination Control in Elevators, AI Magazine, Vol. 23, No. 3, 2002, pp. 59-78. The allocation procedure uses so-called job managers, calculates “costs” and applies one or more cost functions to determine the elevator that can best serve the elevator call, i.e., most cost-effectively, from “offers” from elevators that could serve the elevator call.

In one exemplary embodiment, the control unit 8 or its functionality can be implemented completely or partially in the elevator controller 12. If the elevator system 1 comprises one or more groups of elevators, the functionality of the destination call control system can be implemented completely or partially in a group controller. In one exemplary embodiment, the destination call control system assigns one of, for example, a plurality of elevator cars 10 present in the elevator system 1 to an elevator call (destination call) made by a person P1, P2 at an elevator operating device 4 and communicates the corresponding assignment information via a communication network 24 to the elevator control system 12 and via a communication network 22 to the elevator operating device 4 at which the person P1, P2 is located when the call is made. In another exemplary embodiment of the destination call control system, the elevator operating device 4, at which the person P1, P2 is located when the call is made, determines the elevator that can best serve the elevator call from the offers received.

FIG. 3 is a schematic view of an exemplary embodiment of a communication structure between three illustrated elevator operating devices 4 and the control device 8 of the elevator system 1, which are communicatively connected to the communication network 22. A storage device 20, a communication interface device 30 (COM) and a processor unit 32 (μP) of the control device 8 are shown. The processor unit 32 controls the control device 8 or the storage device 20 and the communication interface device 30. This communication interface device 30 connects the control device 8 to the communication network 22.

For illustrative purposes, FIG. 3 shows one of the elevator operating devices 4 as a mobile phone; said devices display the same custom user interface 4b (FIG. 1). This indicates that the user interfaces 4b in building 2 can be substantially uniform for the person P2 regardless of which elevator operating device 4 the person P2 is at when calling the elevator or which one they use to call the elevator. In one exemplary embodiment, a user profile can be used for this purpose, wherein a user profile can be created for each person P1, P2 or user group registered in the building 2, i.e. it is stored as a data record in a database system.

In one exemplary embodiment, the database is set up in the storage device 20. In FIG. 1, the storage device 20 is arranged centrally in the control device 8 and is thus also communicatively coupled to the communication network 22. However, those skilled in the art will recognize that the storage device 20 or its storage function may be implemented in a different way; for example, the storage device 20 may be implemented in an access control system of the building 2. As an alternative to storing the user profile in the building 2, the user profile may be stored in a database system outside the building 2, with access to this database system being possible via the Internet and/or cloud computing technology. In one exemplary embodiment, the database system can be decentrally implemented in a storage device of the elevator operating devices 4; in this case, the functionality of the custom user interface 4a, 4b can be limited to this elevator operating device 4.

The user profile can comprise personal data about a person P1, P2 (e.g., name, reason for authorization (resident, employee, external service provider, visitor)), access authorizations (e.g., certain rooms 4 and floors) and any temporal access restrictions (e.g., access from Monday to Friday, from 7:00 a.m. to 8:00 p.m.). The user profile of a user group can include data relating to the group members and their authorizations. A user profile for an individual (P1, P2) or a user group can be set for one or more buildings, especially if the user profiles are managed centrally and can be accessed by several buildings. In such a case, one or more details may be specific to a building, for example, a destination floor (default floor) may be set for one building, while this is not the case for another building.

In the following description, the persons P1, P2 are individuals. According to one aspect of the technology described herein, the person P1, P2 can set whether and in what way the user interfaces are to be customized for them in the user profile. For example, the person P1, P2 can set at least one arrangement of input and/or output fields (e.g. destination floor fields 5, information fields 9) on the user interface 4a, 4b, a shape of the input and/or output fields, a color scheme of the input and/or output fields, a color and/or motif of a background of the user interface 4a, 4b, a font and/or a pictogram. Examples of this are described in particular in connection with FIG. 2. In the user profile, for example, it is also possible to set the way in which an assigned elevator is communicated to the person P1, P2, e.g. with or without an audible voice message, with or without displaying the destination floor entered or the desired size with which it is displayed.

The database system and the user profiles it contains can, for example, be centrally administered by a building manager who can create, modify and delete a user profile. An existing user profile can be modified and configured by a person P1, P2 to a defined extent; according to the technology described herein, in particular with regard to displaying the user interface 4a, 4b. Such a change can be made by the person P1, P2, after each authentication on one of the elevator operating devices 4, on a mobile device or on a computer. This can be performed on the mobile device and the computer, for example, after a login process via a web browser application. If an elevator app is installed on the mobile device, the person P1, P2 can make the desired change using the elevator app.

The communication network 22 can comprise a communication bus system, individual point-to-point lines, or a combination thereof. In one embodiment, the communication network 22 may be a wired network. In another embodiment, it may entirely or partially be a radio network; for this purpose, the communication interface device 30 may, for example, comprise a radio interface for mobile radio communication. Depending on the implementation of the communication network 22, individual addresses and/or IDs may be allocated to the control device 8 and each elevator operating device 4 such that, for example, the control device 8 can specifically address and send a message to a certain elevator operating device 4. Communication can take place in accordance with a protocol for wired communication, for example the Ethernet protocol. Through the aforementioned addressing or point-to-point line connection, the control device 8 detects, among other things, on which floor L1, Ln and at which elevator operating device 4 a person P1, P2 calls an elevator. The detected floor L1, Ln indicates the boarding floor for a desired journey to a destination floor.

The mobile device can be, for example, a mobile phone, a smartphone, a tablet PC or a smartwatch, these devices usually being equipped with hardware that enables communication via a local radio network (WLAN/WiFi) and/or a global mobile network according to a mobile communication standard (for example, GSM, LTE, G4, G5). The mobile device may also be spectacles comprising a miniature computer or another body-worn computer-aided device (also referred to as a “wearable device”) if these devices are intended for communication via a local radio network and a global mobile network. Depending on the configuration of the mobile radio network, it can comprise, for example, one or more software applications (apps) and can have a graphical user interface (GUI) in order to be able to selectively activate and deactivate its functions (for example, individual apps). The communication interface device 30 of the control device 8 is designed for communication with such a mobile device.

The person P1, P2 can, for example, enter a desired destination floor on the mobile device or one of the elevator operating devices 4. According to one exemplary embodiment, each elevator operating device 4 (including a mobile device) comprises a display device 3 with a touch-sensitive screen (hereinafter also referred to as a touchscreen). The mode of operation and structure of a touchscreen are generally known to those skilled in the art, in particular those skilled in the art know, for example from the programming and use of smartphones, how symbols, animations, pictograms, input and output fields etc. are generated on a touchscreen and displayed on a graphical user interface. Those skilled in the art also know that an elevator operating device 4 has one or more control and processing devices that control the operation of the elevator operating device 4 and its communication via the communication network 22.

The elevator control device 4 shown in FIG. 2 and the mobile phone display the same user interface 4b also shown in FIG. 1 on the floor Ln in conjunction with the person P2. Regardless of which device (elevator operating device 4 or mobile phone) the person P2 uses, both display the same custom user interface 4b when used. In one exemplary embodiment, the person P2 can modify the display of the user interface 4b on the elevator operating device 4 or on the mobile phone; as a result, the user interface 4b thus modified can then accordingly also be displayed on the other device (elevator operating device 4 or mobile phone) if the person P1, P2 is located there or is operating the other device. In one exemplary embodiment, this is achieved by making the change centrally in the user profile and granting both devices access as needed; in another exemplary embodiment, the change made can be sent via the communication network 22 to one or more devices (elevator operating device 4 or mobile phone) where it is stored.

In one exemplary embodiment, a change in the display of a custom user interface 4a, 4b is made in or for the building 2; this change can be transmitted to another building or made for the other building. The communication network 22 or the communication device 30 can be designed for communication (data exchange) with another building, for example via a public communication network (mobile network, Internet, telephone network); those skilled in the art will recognize that corresponding communication devices are available for this purpose in the other building. It is advantageous for the persons P1, P2 to be able to call an elevator using a user interface 4a, 4b that is familiar to them, even if they are in another building.

With an understanding of the basic structure and function of the elevator system 1 described in connection with FIG. 1, FIG. 2 and FIG. 3, an exemplary embodiment of a method for operating the elevator system 1 is described below with reference to FIG. 4. FIG. 4 shows an example flow chart of the method. For the description of this flow chart, a person P1, P2 is located at an elevator operating device 4 and wishes to modify the user interface displayed by the display device 3. The displayed user interface may be the default user interface 4c or a custom user interface 4a, 4b modified at an earlier time. The method according to FIG. 4 starts in one step, step S1, and ends in one step, S7, wherein the modification or configuration of the user interface is completed in one step, S4.

In one step, step S2, a configuration command is received. The configuration command is generated by an elevator operating device 4 and received by the control device 8 when the person P1, P2 operates the elevator operating device 4 to enter a configuration request. For this purpose, the person P1, P2 can, for example, touch a displayed and correspondingly marked field, e.g. during or after the recording device 7 records a usage feature of the person P1, P2. In one exemplary embodiment, a password (e.g. a key combination) or a biometric feature can be recorded as a usage feature of the person P1, P2.

The usage feature identifies the person P1, P2 as authorized to carry out a configuration. In one exemplary embodiment, the usage feature of the person P1, P2 is received by the control device 8 in conjunction with the configuration command. The control device 8 checks whether authorization to modify the user interface (a custom user interface 4a, 4b that has already been modified at an earlier point in time or the default user interface 4c) is stored in the storage device 20 for the usage feature of the person P1, P2. If authorized, the display device 3 is activated to display a configuration user interface 4d. If not authorized, the display device 3 is instead activated to display an error message. The error message can inform the person P1, P2 that authorization is not given.

In one step, S3, a configuration signal is received. The configuration signal is received by the control device 8 if the person P1, P2 is authorized to make modifications and comprises a custom display instruction set by the first person P1, P2. The custom display instruction modifies the default user interface 4c or the existing custom user interface 4a, 4b.

In one step, S4, the custom display instruction is stored in the storage device 20. The custom display instruction is assigned to a usage feature in the storage device 20. The usage feature can be assigned to the first person P1, P2 or to one or more other persons P1, P2 for whom the custom display instruction is valid. The latter may be the case for the members of a user group for which a person responsible takes over the configuration.

The user profile stored in the storage device 20 is updated when the custom display instruction is saved. The user profile is specific to an individual (P1, P2) or a user group having several group members. In one exemplary embodiment, after the step S4, the configuration of the user interface is completed with the update of the user profile.

Steps S5 and S6 shown in FIG. 4 by way of example concern application examples for activating the display device 3. The control device 8 is designed to activate the display device 3 according to the custom display instruction upon receipt of a usage feature that corresponds to the one stored in the storage device 20, wherein the display device 3 displays a current custom user interface 4a, 4b (step S5). If, however, no usage feature is received or no custom display instruction is set for a received usage feature, the control device 8 activates the display device 3 to display the default user interface 4c (step S6).

The following description contains further details regarding these application examples and the design of the elevator system 1. If a person P1, P2 has configured a custom user interface 4a, 4b, for example as described in connection with FIG. 4, inter alia, and uses the elevator system 1, a recording signal is received. The recording signal is generated by the recording device 7 when the recording device 7 records a usage feature of the person P1, P2. The storage device 20 is searched for a user profile that has the usage feature. The usage feature can be, for example, a password (e.g. an alphanumeric password in conjunction with an RFID card) or a template of a biometric feature (e.g. in conjunction with a facial recognition process). Methods for searching a database for a matching feature are known to those skilled in the art.

If such a user profile is stored, it is determined whether a custom display instruction is set in it. The custom display instruction can be set for the person P1, P2 or for a user group. The display device 3 of the elevator operating device 4 is then activated according to the determined custom display instruction so that the display device 3 displays the custom user interface 4a, 4b.

If no such user profile is stored, the display device 3 of the elevator operating device 4 is activated according to a standard instruction. The display device 3 displays the default user interface 4c; this can, for example, only display destination floor fields 5.

In one exemplary embodiment, the method may further involve reading an operation-specific message from the storage device 20 and activating the display device 3 of the elevator operating device 4 to communicate the operation-specific message. The operation-specific message can be displayed and/or announced. The operation-specific message may include a request; for example, it may ask the person P1, P2 to make a decision. The request may include a transport alternative, an elevator operating setting (e.g., concerning an energy parameter of the elevator system 1) and/or a suggestion to set a destination floor; the person P1, P2 is also asked to decide whether the transport alternative, the elevator operating setting and/or the specification of the destination floor is desired or not.

If the person P1, P2 makes a decision, for example by touching a displayed field (yes or no), in one exemplary embodiment a confirmation signal indicating the decision is received. If the decision is positive or a corresponding confirmation signal is received, the request contained in the operation-specific message is implemented. For example, the person P1, P2 can accept the suggestion to set the destination floor as a standard floor. This decision will be implemented by changing their user profile accordingly. If the decision is negative or if a corresponding confirmation signal is received, the request contained in the operation-specific message will not be implemented; for example, a standard floor will not be set in the user profile.

As explained above, the person P1, P2 may be asked to make one or more changes to the user profile and thus possibly also to the user interface 4a, 4b. An example of a reason for such a request may be that the elevator system 1 detects that the person P1, P2 identified at a specific time is behaving according to a stored behavior pattern because, for example, they want to take a trip at a point in time (day and/or time of day) that they have already taken in the past, but no predefined destination floor is set as the standard floor in their user profile. In this case, an operation-specific message can be read from the storage device 20, which is communicated (e.g. displayed and/or announced) to the person P1, P2 by means of the correspondingly activated display device 3. The operation-specific message informs the person P1, P2 that they can set a destination floor as the standard floor in their user profile, which will be automatically made as an elevator call when a condition (day and/or time of day) that also needs setting is met. The operation-specific message can, for example, ask whether the floor selected by the person P1, P2 should be set as the standard floor. If the person P1, P2 follows this request/message, the confirmation signal is received in response to the operation-specific message, whereupon the user profile of the person P1, P2 is updated in the storage device 20.

Another example reason for such a request may be the effort to optimize, in particular to reduce, the energy requirement of the elevator system 1. For this purpose, an operation-specific message can be read from the storage device 20, which has been set, for example, by a building manager. The operation-specific message may, for example, ask the person P1, P2 whether they would like to be informed about energy-saving options; the corresponding information may, for example, be displayed on the user interface 4a, 4b, e.g., it may indicate that the elevator system 1 is in the elevator operating setting “energy-saving mode.” The information may include a transport alternative, e.g. that, for energy reasons, it is more economical to use a staircase for a floor difference of one or two floors, or to take the stairs to the next floor and then take the elevator because this floor is served more frequently. The transport alternative can be offered generally or depending on the day of the week or the time of day. If the person P1, P2 agrees with the operation-specific message displayed, a confirmation signal is received in response, whereupon the user profile of the person P1, P2 is updated in the storage device 20.

1. A method for operating an elevator system, wherein the elevator system comprises a control device, an elevator car-which can move between floors, and an elevator operating device having a display device, wherein the elevator operating device is configured to activate the display device to display a user interface said method comprising:
receiving a configuration command via the control device, wherein the configuration command indicates that a first person wishes to modify a default user interface or an existing custom user interface;
receiving a configuration signal via the control device comprising a custom display instruction set by the first person, wherein the custom display instruction modifies the default user interface or the existing custom user interface; and
storing the custom display instruction in a storage device, wherein the custom display instruction is assigned to a usage feature in the storage device and wherein the usage feature is assigned to the first person or to one or more additional persons for whom the custom display instruction is valid,
wherein the control device is configured to activate the display device according to the custom display instruction upon receipt of a usage feature that corresponds to the one stored in the storage device, wherein the display device displays a current custom user interface.

2. The method according to claim 1, wherein the configuration command is associated with a usage feature of the first person, and wherein the method further includes:
receiving the usage feature of the first person via the control device;
using the control device to check whether authorization to modify the user interface is stored in the storage device for the usage feature of the first person;
if authorized, activating the display device to display a configuration user interface; and
if not authorized, activating the display device to display an error message.

3. The method according to claim 1, wherein the custom display instruction specifies at least one arrangement of input and/or output fields on the custom user interface, a shape of the input and/or output fields, a color scheme of the input and/or output fields, a color scheme and/or motif design of a background of the custom user interface, and a font and/or a pictogram for the custom user interface.

4. The method according to claim 1, wherein, during storage, a user profile stored in the storage device is updated, wherein the user profile is specific to an individual or a user group having several group members.

5. The method according to claim 1, wherein the configuration command and the configuration signal are received from an elevator operating device, a mobile device or a computer.

6. The method according to claim 1, wherein the storage device is arranged in the elevator operating device or wherein the storage device is arranged so as to be connected to the control device of the elevator system.

7. The method according to claim 1, wherein the usage feature is an alphanumeric password or a template of a biometric feature, wherein the alphanumeric password is determined by a recording device from a scanned optical code, a received electrical signal or a received radio signal, and wherein the template is determined by the recording device from an image of the face of the person.

8. An elevator system, comprising:
an elevator car configured to move between floors;
an elevator operating device having a display device, wherein the elevator operating device is configured to activate the display device to display a user interface;
a storage device; and
a control device, wherein the control device is configured to:
receive a configuration command, wherein the configuration command indicates that a first person wishes to modify a default user interface or an existing custom user interface,
receive a configuration signal comprising a custom display instruction set by the first person, wherein the custom display instruction modifies the default user interface, and
cause the custom display instruction to be stored in the storage device, wherein the custom display instruction is assigned to a usage feature in the storage device and wherein the usage feature is assigned to the first person or to one or more additional persons for whom the custom display instruction is valid,
wherein the control device is further configured to control the display device according to the custom display instruction upon receipt of a usage feature that corresponds to the one stored in the storage device, wherein the display device displays a custom user interface.

9. The elevator system according to claim 8, further comprising a recording device which is assigned to the elevator operating device on a floor and is configured to generate a recording signal when the recording device records a usage feature of a person.

10. The elevator system according to claim 8, wherein the configuration command is associated with a usage feature of the first person and wherein the control device is further configured to:
receive the usage feature of the first person,
check whether authorization to modify the user interface is stored in the storage device for the usage feature of the first person;
if authorized, activate the display device to display a configuration user interface; and
if not authorized, activate the display device to display an error message.

11. The elevator system according to claim 8, wherein the custom display instruction specifies at least one arrangement of input and/or output fields, on the custom user interface, a shape of the input and/or output fields, a color of the input and/or output fields, a color and/or motif of a background of the custom user interface and a font and/or pictogram for the custom user interface.

12. The elevator system according to claim 10, wherein the storage device is arranged in the elevator operating device or wherein the storage device is arranged so as to be connected to a control device of the elevator system.

13. The elevator system according to claim 10, wherein the control device is configured to use a received destination call for a journey of the person from a boarding floor to a destination floor to determine the boarding floor and the destination floor, wherein the destination call is made from the elevator operating device.

14. The elevator system according claim 11, wherein the control device is configured to use a received destination call for a journey of the person from a boarding floor to a destination floor to determine the boarding floor and the destination floor, wherein the destination call is made from the elevator operating device.
